(19) United States
(12) Patent Application Publication
(10) Pub. No.: US 2020/0088168 A1
(43) Pub. Date: Mar. 19, 2020

(54) A WIND TURBINE WITH A CABLE SUPPORTING STRUCTURE

(71) Applicant: Vestas Wind Systems A/S, Aarhus N. (DK)

(72) Inventor: Torben Ladegaard Baun, Skødstrup (DK)

(21) Appl. No.: 16/470,643

(22) PCT Filed: Dec. 4, 2017
(86) PCT No.: PCT/DK2017/050407

§ 371 Date: Jun. 18, 2019

(30) Foreign Application Priority Data
Dec. 21, 2016 (DK) PA 2016 71010

(51) Int. Cl. F03D 9/30; F03D 80/50

(52) U.S. Cl. CPC F03D 9/30; F03D 80/50

(57) ABSTRACT

A wind turbine (1) comprising a tower structure comprising a main tower part (2) extending along a substantially vertical direction and at least two arms(3) is disclosed. Each arm (3) extends away from the main tower part (2) along a direction having a horizontal component, and the arms (3) are arranged to perform yawing movements. Two or more energy generating units (4) are mounted on the tower structure in such a manner that each arm (3) of the tower structure carries at least one energy generating unit(4), each energy generating unit (4) comprising a rotor (5) with a hub carrying a set of wind turbine blades(6). The main tower part (2) is provided with a cable supporting structure (7) allowing power cables (8) of a power grid to be mounted on the main tower part (2).

### FIELD OF THE INVENTION

The present invention relates to a wind turbine of the kind comprising two or more energy generating units, each energy generating unit comprising a rotor with a hub carrying a set of wind turbine blades. Such a wind turbine is sometimes referred to as a multi-rotor wind turbine. The wind turbine according to the invention comprises a cable supporting structure allowing power cables of a power grid to be mounted on a tower structure of the wind turbine.

### BACKGROUND OF THE INVENTION

When erecting a wind turbine, various costs are involved, including manufacturing costs for the tower construction arranged to carry one or more energy generating units and costs related to preparing the site where the wind turbine is erected. For instance, a foundation for the wind turbine may be required, which is capable of withstanding any loads or torques which the tower structure of the wind turbine may be subjected to during operation of the wind turbine. Furthermore, it may be necessary to prepare the ground in an area surrounding the wind turbine, e.g. in order to ensure that heavy equipment used during erection of the wind turbine and/or during service of the wind turbine can gain access to the site. It may also be necessary to clear the site, e.g. by cutting down trees. Finally, restrictions may apply to the usage of an area arranged within a certain distance from the wind turbine.

Similar costs and restrictions may apply to the erection of masts carrying power cables for a power grid.

WO 2009/100392 A2 discloses towers and tower base sections for use with electrical generators and with electrical transmission lines. The towers may be configured to support a wind turbine generator and to support electrical transmission lines.

U.S. Pat. No. 6,400,039 B1 discloses a wind power installation comprising a pylon, a foundation for the pylon and an energy transfer unit for transfer of the current generated to the power network. The energy transfer unit may be disposed approximately at the height of an overland power line of the power network, to which the wind power installation is connected.

In the wind turbines and towers disclosed in WO 2009/100392 A2 and U.S. Pat. No. 6,400,039 B1, the rotors are arranged at or near a main tower part, extending along a substantially vertical direction. Thereby, in the case that it is necessary to perform service requiring components to be hoisted to or from the rotors, such components need to be hoisted near the power cables mounted on the wind turbine tower. It may further be necessary for service personnel to operate near the power cables. This introduces safety risks.

### DESCRIPTION OF THE INVENTION

It is an object of embodiments of the invention to provide a multi-rotor wind turbine having power cables mounted on a tower structure thereof, which allows service to be performed on the energy generating units of the wind turbine in a safe manner.

It is a further object of embodiments of the invention to provide a method for performing service on an energy generating unit of a wind turbine having power cables mounted on a tower structure thereof, the method allowing the service to be performed in a safe manner.

It is an even further object of embodiments of the invention to provide a method for mounting power cables on a wind turbine structure in a fast and efficient manner.

According to a first aspect the invention provides a wind turbine comprising:
a tower structure comprising a main tower part being anchored, at a lower part, to a foundation structure, the main tower part extending along a substantially vertical direction, the tower structure further comprising at least two arms, each arm extending away from the main tower part along a direction having a horizontal component, the arms being arranged to perform yawing movements about an axis defined by the substantially vertical direction of the main tower part, and
two or more energy generating units mounted on the tower structure in such a manner that each arm of the tower structure carries at least one energy generating unit, each energy generating unit comprising a rotor with a hub carrying a set of wind turbine blades,

wherein the main tower part is provided with a cable supporting structure allowing power cables of a power grid to be mounted on the main tower part, the main tower part thereby being configured to function as a power mast.

The wind turbine according to the first aspect of the invention comprises a tower structure and two or more energy generating units. Accordingly, the wind turbine is a multi-rotor wind turbine.

The tower structure comprises a main tower part being anchored, at a lower part to a foundation structure. The main tower part further extends along a substantially vertical direction. Thus, the main tower part resembles a traditional wind turbine tower for a single rotor wind turbine.

The tower structure further comprises at least two arms extending away from the main tower part along a direction having a horizontal component. The arms may extend away from the main tower part along a substantially horizontal direction. In this case the arms extend substantially perpendicularly to the vertically arranged main tower part. As an alternative, the arms may extend away from the main tower part along a direction which has a horizontal component as well as a vertical component. In this case the arms extend away from the main tower part at an angle with respect to the main tower part which differs from 90°. The angle defined between the arms and the main tower part may advantageously be between 45° and 90°.

In any event, since the arms of the tower structure extend away from the main tower part along a direction having a horizontal component, they do not extend parallel to the vertical main tower part, but instead at an angle with respect to the main tower part. The arms may be attached to or form part of the main tower part in such a manner that the angle defined between the main tower part and a given arm is fixed.

The arms may be in the form of trusses, beams, systems of beams, lattice structures, etc. Furthermore, the arms may not necessarily be linear structures, but they may have a rounded or curved shape.

Thus, the tower structure comprises a substantially vertical main part, and at least two arms extending therefrom in a non-vertical direction.

The arms are arranged to perform yawing movements. Thus, the arms are capable of performing rotating movements about an axis which substantially coincides with the vertical direction defined by the main tower part. Since the arms extend from the main tower part along a non-vertical direction, performing yawing movements of an arm will cause a change in the direction along which the arm extends away from the main tower part. This will be described in further detail below.

The yawing movements of each arm may be performed relative to the main tower part. In this case, the tower structure may comprise a yawing mechanism arranged at an interface between the main tower part and each arm. As an alternative, the arms may be fixedly mounted on an upper portion of the main tower part which is capable of performing yawing movements with respect to a lower portion of the main tower part. As another alternative, the entire main tower part, carrying the arms, may be capable of performing yawing movements, e.g. with respect to the foundation structure.

The wind turbine further comprises two or more energy generating units. Each energy generating unit comprises a rotor with a hub carrying a set of wind turbine blades. Thus, the energy generating units form the part of the wind turbine which actually transforms the energy of the wind into electrical energy. The wind acts on the wind turbine blades, thereby causing the hub to rotate. The rotational movements of the hub are transferred to a generator, either via a gear arrangement or directly. In the generator, electrical energy is generated, which may be supplied to a power grid. In addition to the rotor, hub and wind turbine blades, each energy generating unit may comprise a generator and possibly a gear arrangement interconnecting the rotor and the generator. The generator, and possibly the gear arrangement, may be arranged inside a nacelle.

The rotors may advantageously be of a horizontal axis type (HAWT), i.e. of a type where the rotational axis of the rotor is arranged along a substantially horizontal direction.

The energy generating units are mounted on the tower structure in such a manner that each arm of the tower structure carries at least one energy generating unit. For instance, the energy generating units may be arranged at or near and end of each arm which is furthest away from the main tower part. Accordingly, the energy generating units are arranged at a distance from a vertical centre axis defined by the main tower part.

Finally, the main tower part is provided with a cable supporting structure allowing power cables of a power grid to be mounted on the main tower part.

Thereby the tower structure of the wind turbine is also capable of filling the function of a power mast. Accordingly, the total costs involved with providing wind turbines as well as power masts for a power grid can be reduced, since a single structure is used for both purposes. Furthermore, the total required ground area can be reduced.

It should be noted that, in the present context, the cable supporting structure is primarily a mechanical structure, allowing main power cables to be mechanically mounted on the main tower part. Thus, the power cables are normally not electrically connected to the wind turbine via the cable supporting structure. However, it is not ruled out that the cable supporting structure is also adapted to carry cables which are electrically connected to the wind turbine. Such cables could, e.g., be low voltage cables used for supplying power produced by the wind turbine to a remotely positioned transformer. In this case, the transformer may receive power produced by several wind turbines. The transformer may further be connected to the main power cables mounted on the wind turbines, thereby supplying high voltage power to the power grid.

In the present context the term ‘main power cables’ should be interpreted to mean power cables which form part of a power grid. Such power cables normally extend over long distances and are suspended between power masts.

As described above, the arms of the tower structure are arranged to perform yawing movements, and performing such yawing movements will cause a change in the direction along which a given arm extends away from the main tower part. Accordingly, it is possible to move a given arm to a position where the arm extends along a direction which is not parallel to a direction along which the power cables mounted on the main tower part extend. Thereby an energy generating unit carried by the arm can be moved to a position which is not immediately above the power cables, and this allows service to be performed on the energy generating unit in a safe manner and with all service operations being performed at a position which is well clear of the power cables.

The arms of the tower structure may form part of a single transverse structure. According to this embodiment, the arms are not movable with respect to each other, and the yawing movements may advantageously be performed by rotating the entire transverse structure. The transverse structure may, e.g., form an upper portion of the main tower part. Alternatively, it may be mounted on the main tower part via a yawing mechanism.

As an alternative, each arm may be mounted on the main tower part via an individual yawing mechanism. As another alternative, some of the arms may form part of a single transverse structure, while other arms may be disconnected from the transverse structure. For instance, the tower structure may comprise four arms, two of the arms forming part of a first transverse structure and the other two arms forming part of a second transverse structure. The first transverse structure may, in this case, be mounted on the main tower part at a higher level than the second transverse structure.

The cable supporting structure may be mounted on the main tower part of the tower structure at a position which is lower than a connecting position between the main tower part and at least two of the arms. This allows the rotors of the energy generating units being carried by these at least two arms to be arranged at a high level, where the wind speed can be expected to be higher than at lower levels. This increases the total energy production of the wind turbine. Furthermore, the power cables are mounted on the main tower part at a level where they can easily be reached, e.g. in order to perform service on the power cables or on the cable supporting structure.

The cable supporting structure may be mounted on the main tower part at a position below all of the arms of the tower structure. As an alternative, it may be mounted below some of the arms and above some of the arms.

The cable supporting structure may be or comprise a cassette arranged to hold the power cables, the cassette being configured to be hoisted along the main tower part of the tower structure. According to this embodiment, the power cables may be mounted on the cassette while the cassette is arranged on the ground, and the cassette may subsequently be hoisted along the main tower part to the mounting position, along with the power cables. Finally, the cassette may be mounted on the main tower part. Thereby the amount of work which needs to be performed at the mounting position, i.e. above ground level, is minimised, since the task of mounting the individual power cable in the cassette is performed on the ground. This increases the safety and reduces costs.

As an alternative, once the cassette and the power cables have been hoisted to the mounting position, the power cables may be attached to a cable supporting structure which has previously been mounted on the main tower part, or which forms a part of the main tower part. The cassette may subsequently be lowered to the ground. In this case the cassette does not form part of the cable supporting structure, but it still provides an easy manner of hoisting the power cables to the mounting position.

As another alternative, the power cables may be hoisted to the mounting position in any other suitable manner.

The cassette may be hoisted to the mounting position by means of a jacking mechanism, by means of a service crane arranged in the tower structure or in one or more of the energy generating units, or using any other suitable kind of equipment.

The cable supporting structure may have an aerodynamic shape arranged for directing wind towards the energy generating units. According to this embodiment, incoming wind at the cable supporting structure is directed towards the energy generating units, and thereby the wind speed at the positions of the energy generating units is increased. This increases the total power production of the wind turbine.

The aerodynamic shape of the cable supporting structure could, e.g., include a curved surface, which deflects the incoming wind towards the energy generating units. The curved surface could be rotationally symmetric, in which case incoming wind is deflected in the same manner, regardless of the wind direction. Alternatively, the curved surface may be shaped in such a manner that the ability of the curved surface to deflect the incoming wind is better at some wind directions, e.g. parallel to the direction defined by the power cables, than at other wind directions.

As an alternative, the aerodynamic shape of the cable supporting structure may define a funnel or the like, which directs the wind towards the energy generating units.

As an alternative, the cable supporting structure may have any other suitable kind of shape. For instance, it may be a truss structure, similar to the structures which carry power cables in standard power masts.

The cable supporting structure may be mounted on the main tower part of the tower structure via a vibration dampening arrangement. According to this embodiment, transfer of vibrations between the wind turbine and the power cables is reduced or even avoided. This includes transfer of vibrations from the power cables of the power grid to the wind turbine, as well as transfer of vibrations from the wind turbine to the power cables of the power grid.

The vibration dampening arrangement may, e.g., include a resilient member, such as a rubber member or a spring, arranged at an interface between the cable supporting structure and the main tower part. Alternatively or additionally, the vibration dampening arrangement may include viscous dampers, tuned mass dampers, and/or any other suitable kind of damper.

A service crane arranged in the tower structure or in one of the energy generating units may be configured for use during service of the power cables and/or the cable supporting structure. According to this embodiment, a crane which is already present in the tower structure or in one of the energy generating units can be used when service on the power cables and/or on the cable supporting structure is required. Thereby it is not necessary to provide a separate crane, such as a mobile crane, in order to perform such service. This considerably reduces the costs involved with performing service on the power cables and/or on the cable supporting structure. This embodiment of the invention is particularly relevant when the cable supporting structure is mounted on the main tower part at a position which is lower than a connecting position between the main tower part and at least two of the arms, since this allows the service crane to be arranged above the level of the power cables and the cable supporting structure.

At least one of the arms of the tower structure may be provided with a hatch allowing a part of the service crane to pass there through. According to this embodiment, the service crane may advantageously be arranged in the arm in which the hatch is provided. When service on the power cables and/or on the cable supporting structure is required, the hatch can be opened, and a relevant part of the service crane, such as a hook mounted on a wire, can be passed through the hatch and lowered to the position of the cable supporting structure and the power cables. The service crane can then be used for lowering and/or hoisting spare parts, service tools or any other relevant equipment from/to the position of the cable supporting structure and the power cables, and the relevant service can then be performed.

As an alternative, the service crane may be arranged in the main tower part or in one of the energy generating units. In this case, a relevant part of the service crane may still be passed through a hatch formed in one of the arms. Alternatively, a relevant part of the service crane may be passed through a hatch formed in the main tower part or in a nacelle of an energy generating unit.

The service crane may further be used for hoisting the cable supporting structure and/or the power cables to the mounting position on the main tower part and/or for lowering the cable supporting structure and/or the power cables from the mounting position on the main tower part towards the ground. In this case the hoisting and/or lowering may advantageously be performed using two different service cranes arranged on opposite sides of the main tower part, e.g. in two different arms or in energy generating units mounted on two different arms, in order to balance the hoisting/lowering process.

According to a second aspect the invention provides a method for performing service on an energy generating unit of a wind turbine according to the first aspect of the invention, the method comprising the steps of:
performing yawing movements of at least one of the arms of the tower structure, in order to move the arm to a position in which an energy generating unit carried by the arm is clear of the power cables mounted on the main tower part, and
performing service on the energy generating unit while the arm is in this position.

The method according to the second aspect of the invention is a method for performing service on an energy generating unit of wind turbine according to the first aspect of the invention. Accordingly, the remarks set forth above with reference to the first aspect of the invention are equally applicable here.

Initially, yawing movements of at least one of the arms of the tower structure are performed, in order to move the arm to a position in which an energy generating unit carried by the arm is clear of the power cables mounted on the main tower part. Thereby the energy generating unit is arranged in a position where no power cables are arranged in the space immediately below the energy generating unit, and thereby it is possible to gain access to the energy generating unit in a safe manner. For instance, service personnel will not have to work close to the power cables, and spare parts, service equipment, etc. can be directly hoisted to and lowered from the energy generating unit without risking collisions with the power cables.

Thus, service is performed on the energy generating unit while the arm is in this position, i.e. the service can be performed in a safe manner. This is only possible because the energy generating unit is mounted on an arm extending away from the main tower part, and because the arm is capable of performing yawing movements.

The step of performing yawing movements may be performed in such a manner that only one arm is moved. Alternatively, two or more arms may be moved simultaneously. This may, e.g., be the case if the arms are mounted on or form part of a single transverse structure.

The step of performing yawing movements may comprise moving the arm to a position in which the arm extends away from the main tower part along a direction which defines an angle of approximately 90° with a direction defined by the power cables mounted on the main tower part. According to this embodiment, the arm is arranged substantially perpendicularly to the power cables. Thereby the distance from the energy generating unit to the power cables is maximized, thereby maximizing the safety while performing service.

This position is particularly suitable in the case that service personnel needs to work immediately below the energy generating unit and/or if components, spare parts, service equipment, etc. needs to be hoisted to and/or lowered from a nacelle of the energy generating unit.

As an alternative, the step of performing yawing movements may comprise moving the arm to a position in which the arm extends away from the main tower part along a direction which defines an angle of approximately 70° with a direction defined by the power cables mounted on the main tower part. According to this embodiment, the energy generating unit is arranged well clear of the power cables. Furthermore, the rotor of the energy generating unit can be oriented in a direction which points away from the power cables. This position is particularly suitable in the case that the rotor or one or more wind turbine blades need to be exchanged or installed.

According to a third aspect the invention provides a method for mounting power cables on a wind turbine according to the first aspect of the invention, the method comprising the steps of:
arranging a cassette on the ground at a position near the main tower part of the tower structure,
attaching power cables to the cassette,
attaching the power cables to cassettes of at least one neighbouring wind turbine, and
hoisting the cassette along the main tower part, the hoisting being coordinated with hoisting the cassettes of the neighbouring wind turbines.

The method according to the third aspect of the invention is a method for mounting power cables on a wind turbine according to the first aspect of the invention. Accordingly, the remarks set forth above with reference to the first aspect of the invention are equally applicable here.

A cassette is initially arranged on the ground at a position near the main tower part of the tower structure, and power cables are attached to the cassette. The power cables are also attached to cassettes of at least one neighbouring wind turbine. Thereby the power cables interconnect at least two cassettes, each cassette being arranged on the ground near a main tower part of a wind turbine.

Finally, the cassette is hoisted along the main tower part, in order to arrange the cassette at a mounting position for the power cables on the main tower part. The hoisting is coordinated with hoisting of the cassettes of the neighbouring wind turbines. Thereby it can be ensured that the power cables attached to one cassette are not hoisted to a position where the distance from that cassette to a neighbouring cassette exceeds the length of the power cables interconnecting the two cassettes. Thereby the power cables can be attached to the cassettes prior to the hosting, without risking that the power cables break during the hoisting, and a subsequent adjustment of the power cables is not necessary. Accordingly, a significant part of the mounting process can be performed while the power cables and the cassettes are still on the ground. This increases the safety and reduces the costs.

For instance, the coordinated hoisting of the cassettes may be performed in the following manner. Initially, a first cassette may be moved a small distance along the corresponding main tower part. Then the neighbouring cassette may be moved a similar distance along the main tower part where this cassette is arranged. Subsequently the next cassette may be moved a similar distance, etc. Once the second cassette has been moved a small distance, the first cassette may be moved further on along the main tower part. This incremental movement of all of the cassettes is continued until all of the cassettes are arranged at the mounting positions on the respective main tower parts.

As an alternative, each cassette may be hoisted in a substantially continuous manner, but the movement the cassettes may be initiated in a sequential manner, thereby ensuring that the distance between neighbouring cassettes does not exceed the length of the power cables interconnecting the cassettes.

The step of hoisting the cassette may be performed using a jacking mechanism. According to this embodiment, no external crane is required in order to hoist the cassette to the mounting position.

Alternatively or additionally, the step of hoisting the cassette may be performed using at least one service crane arranged in the tower structure or in one of the energy generating units of the wind turbine. Also in this case, an external crane is not required. As described above, the hoisting may advantageously be performed using two service cranes arranged on opposite sides of the main tower part, in order to balance the hoisting process.

The method may further comprise the steps of mounting the power cables on the main tower part by means of a cable supporting structure, and subsequently lowering the cassette to the ground. According to this embodiment, the cassette is merely used for hoisting the power cables to the mounting position, but it does not form part of the cable supporting structure. Instead, the power cables are attached to a cable supporting structure, which has previously been mounted on the main tower part, or which forms part of the main tower part, after the power cables have been hoisted to the mounting position as described above.

Alternatively, the method may further comprise the step of mounting the cassette on the main tower part, the cassette thereby forming a cable supporting structure. According to this embodiment, the power cables remain attached to the cassette, and only the cassette needs to be mounted on the main tower part.

### BRIEF DESCRIPTION OF THE DRAWINGS

The invention will now be described in further detail with reference to the accompanying drawings in which

FIG. 1 is a front view of two wind turbines according to a first embodiment of the invention,

FIG. 2 is a perspective view of one of the wind turbines of FIG. 1,

FIG. 3 is a top view of one of the wind turbines of FIG. 1, in a first position,

FIG. 4 is a top view of one of the wind turbines of FIG. 1, in a second position,

FIG. 5 illustrates mounting of a rotor on a wind turbine according to an embodiment of the invention,

FIG. 6 illustrates service being performed on a cable supporting structure mounted on a wind turbine according to an embodiment of the invention,

FIG. 7 is a perspective view of a wind turbine according to a second embodiment of the invention,

FIG. 8 illustrates mounting of power cables on wind turbines in accordance with a method according to an embodiment of the invention,

FIG. 9 is a front view of two wind turbines according to a third embodiment of the invention, and

FIGS. 10-12 show various cable supporting structures for a wind turbine according to an embodiment of the invention.

### DETAILED DESCRIPTION OF THE DRAWINGS

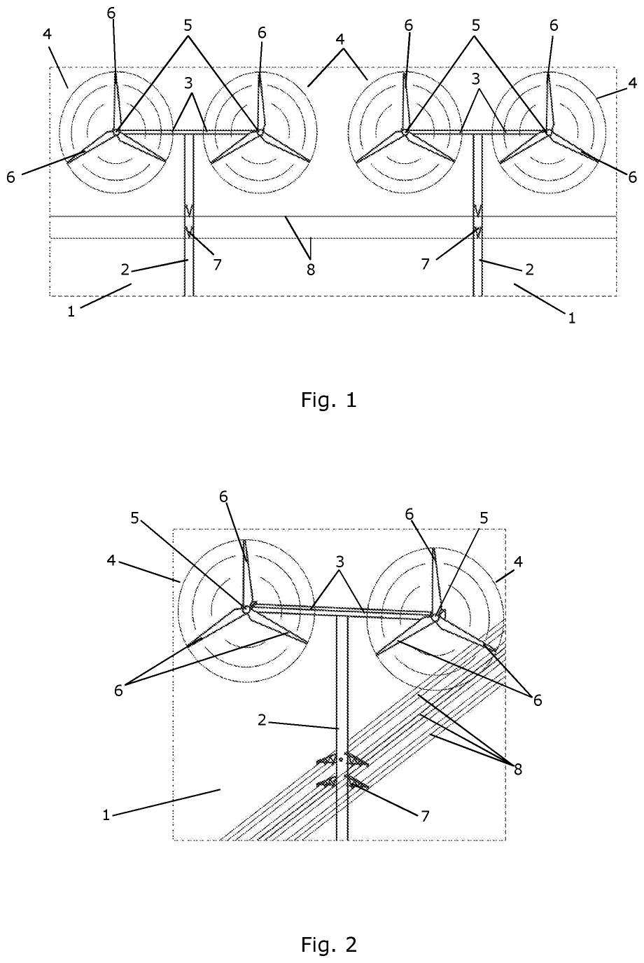

FIG. 1 is a front view of two wind turbines 1 according to a first embodiment of the invention. Each wind turbine 1 comprises a tower structure with a main tower part 2 extending along a substantially vertical direction, and two arms 3, each arm extending away from the main tower part 2 along a substantially horizontal direction. It should be noted that the arms 3 could, alternatively, extend away from the main tower part 2 along a direction which forms an angle with the vertical direction defined by the main tower part 2, which differs from 90°, as long as the direction has a horizontal component. For instance, the arms 3 may extend along a direction which is inclined, following an upwards direction from the main tower part 2 towards a free end of the arm 3.

Each arm 3 carries an energy generating unit 4 comprising a rotor 5 with a set of wind turbine blades 6.

The main tower part 2 of each wind turbine 1 is further provided with a cable supporting structure 7, and a number of power cables 8, two of which are shown, of a power grid are attached to the main tower parts 2 of the wind turbines 1, via the cable supporting structures 7. Accordingly, the main tower parts 2 serve the function of wind turbine towers as well as the function of power masts. This allows the total costs of establishing the wind turbines 1 as well as the power grid to be reduced.

The arms 3 are arranged to perform yawing movements, i.e. rotating movements about a substantially vertical axis which coincides with the vertical direction defined by the corresponding main tower part 2. This allows the arms 3 to be arranged in any suitable orientation with respect to the direction along which the power cables 8 extend. Accordingly, the energy generating units 4 can be arranged in a position which is well clear of the power cables 8, and this allows service to be performed on the energy generating units 4 in a safe manner. This will be described in further detail below.

In the embodiment of FIG. 1, the arms 3 of each wind turbine 1 form part of a single transversal structure, and thereby the arms 3 are moved together when yawing movements are performed.

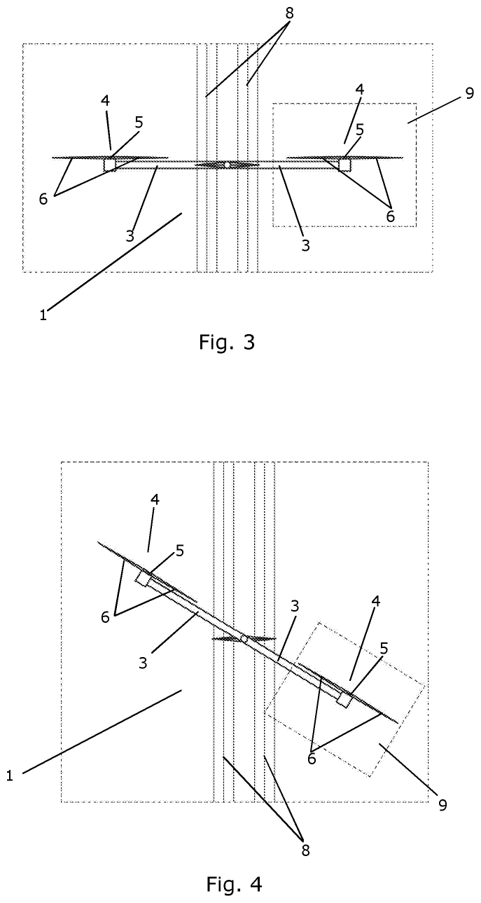

FIG. 2 is a perspective view of one of the wind turbines 1 of FIG. 1. The arms 3 have been yawed to a position where they extend along a direction which is not parallel to the direction along which the power cables 8 extend.

FIG. 3 is a top view of one of the wind turbines 1 of FIG. 1. In FIG. 3, the arms 3 have been yawed to a position where they extend along a direction which is substantially perpendicular to the direction along which the power cables 8 extend. In this position, the energy generating units 4 are positioned as far away from the power cables 8 as possible. This allows service to be performed on the energy generating units 4 in a safe manner, i.e. without risking collisions with the power cables 8. In particular, components may be hoisted directly to and from the energy generating unit 4 without risking collisions between the components and the power cables 8. Furthermore, the service can be performed from a hardstand 9 formed at a distance from the main tower part of the wind turbine.

FIG. 4 is also a top view of one of the wind turbines 1 of FIG. 1. In FIG. 4, the arms 3 have been yawed to a position where they extend along a direction which forms an angle of approximately 70° with the direction along which the power cables 8 extend. In this position, the energy generating units 4 are also arranged at a distance from the power cables 8. Furthermore, the rotor 5 of one of the energy generating units 4 points in a direction away from the power cables 8. This allows the entire rotor 5 or one or more wind turbine blades 6 to be hoisted to or from the energy generating unit 4 from the hardstand 9, without risking collisions with the power cables 8, and while personnel and possibly an external crane can be position at a safe distance from the power cables 8.

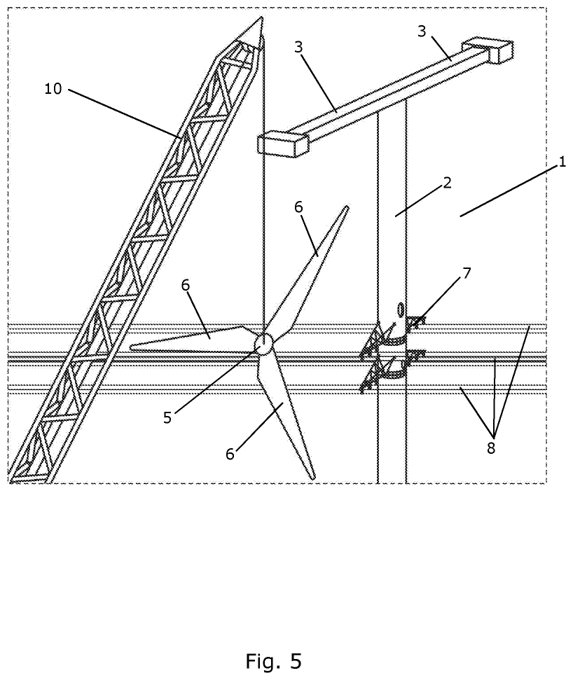

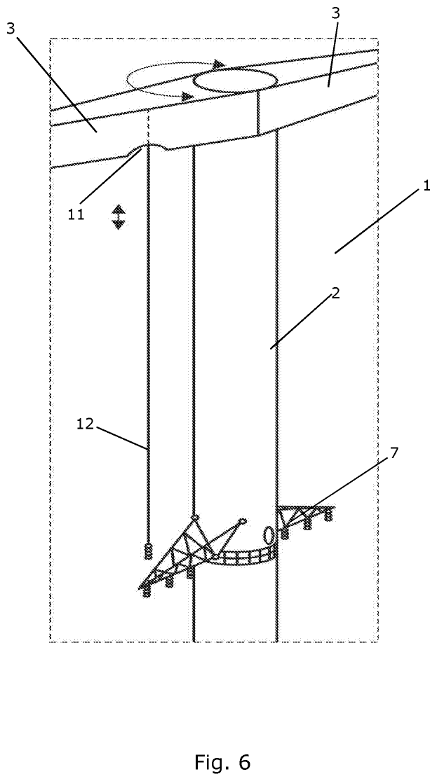

FIG. 5 illustrates mounting of a rotor 5 on a wind turbine 1 according to an embodiment of the invention. The wind turbine 1 comprises a tower structure with a main tower part 2 and two arms 3, each being adapted to carry an energy generating unit. A cable supporting structure 7 having a number of power cables 8 attached thereto is mounted on the main tower part 2. The wind turbine 1 could, e.g., be of the kind illustrated in FIGS. 1-4.

An external crane 10 is in the process of hoisting a rotor 5 with three wind turbine blades 6 to an operating position on the wind turbine 1. The arms 3 of the wind turbine 1 have been yawed to a position in which they extend along a direction which is not parallel to the direction along which the power cables 8 extend. Thereby the ends of the arms 3 are arranged at positions which are well clear of the power cables 8, and can therefore be accessed in a safe manner without risking collisions with the power cables 8. The arms 3 could, e.g., be yawed to the position illustrated in FIG. 4.

FIG. 6 illustrates service being performed on a cable supporting structure 7 mounted on a wind turbine 1 according to an embodiment of the invention. The wind turbine 1 comprises a tower structure with a main tower part 2 and two arms 3, each being adapted to carry an energy generating unit. A hatch 11 is formed in one of the arms 3 of the wind turbine 1, allowing a wire 12 of a service crane (not shown) arranged in the arm 3, in the main tower part 2 or in an energy generating unit to pass there through, as shown in FIG. 6. Thereby the service crane can be used for performing service on the cable supporting structure 7. Furthermore, in the case that power cables are attached to the cable supporting structure 7, the service crane could also be used for performing service on the power cables. Finally, the service crane could be used for hoisting the cable supporting structure 7 and/or power cables to or from the mounting position on the main tower part 2.

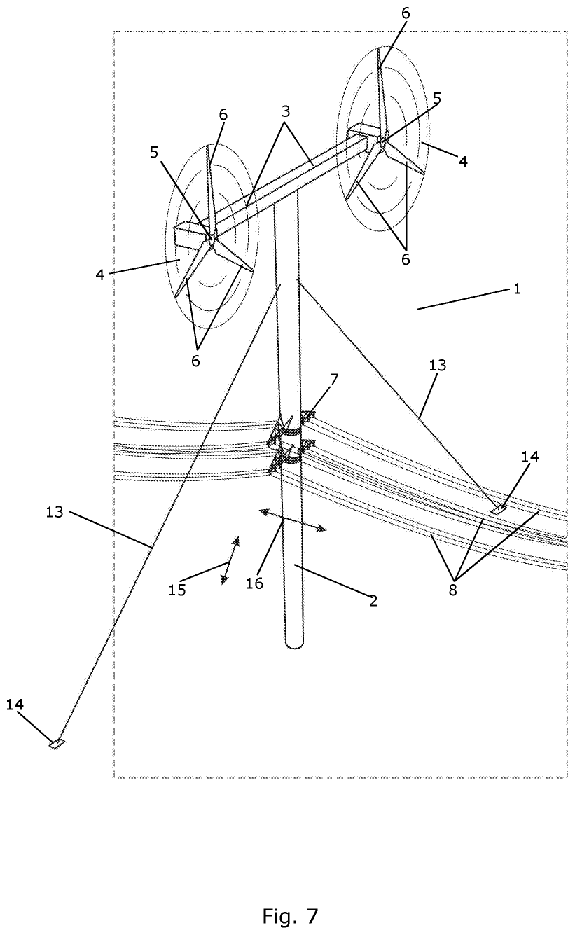

FIG. 7 is a perspective view of a wind turbine 1 according to a second embodiment of the invention. The wind turbine 1 according to the second embodiment of the invention is similar to the wind turbine 1 according to the first embodiment of the invention in the sense that it comprises a tower structure with a main tower part 2 and two arms 3, each arm carrying an energy generating unit 4 with a rotor 5 carrying a set of wind turbine blades 6, and in the sense that a cable supporting structure 7 having a number of power cables 8 attached thereto is mounted on the main tower part 2.

The wind turbine 1 of FIG. 7 is further provided with two guy wires 13, each being attached to the main tower part 2 and anchored to the ground by means of an anchor block 14. The guy wires 13 are capable of handling part of the loads on the wind turbine 1, which can be expected during normal operation. However, the guy wires 13 will only be able to handle loads, in particular bending loads, along the direction indicated by arrow 15, but not loads along the direction indicated by arrow 16, due to the positions of the guy wires 13. However, loads along the direction indicated by arrow 16 can be partly handled by the power cables 8. Accordingly, a set of guy wires 13 and a set of anchoring points 14 can be omitted.

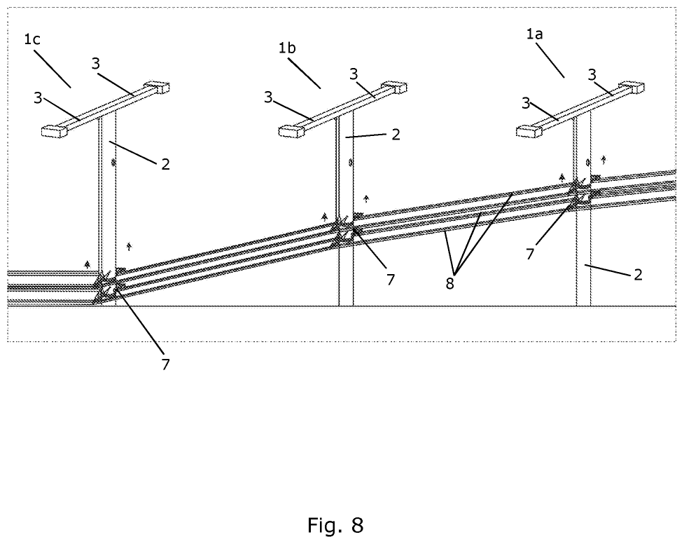

FIG. 8 illustrates mounting of power cables 8 on wind turbines 1 in accordance with a method according to an embodiment of the invention. FIG. 8 shows three wind turbines 1, each comprising a tower structure with a main tower part 2 and two arms 3. Cable supporting structures 7 having power cables 8 attached thereto are being mounted on the main tower parts 2 of the wind turbines 1 in the following manner.

Initially, a cable supporting structure 7, in the form of a cassette, is positioned on the ground near each of the wind turbines 1. Power cables 8 are then attached to the cable supporting structures 7 in such a manner that neighbouring cable supporting structures 7 are interconnected by the power cables 8.

Then the cable supporting structure 7 of a first wind turbine 1a is hoisted slightly along the main tower part 2 of the wind turbine 1a. When the cable supporting structure 7 has reached a certain level, hoisting of the cable supporting structure 7 of a second wind turbine 1b is initiated. The second wind turbine 1b is a neighbouring wind turbine with respect to the first wind turbine 1a, in the sense that the cable supporting structures 7 of the first wind turbine 1a and the second wind turbine 1b are directly interconnected by the power cables 8. The hoisting of the cable supporting structure 7 of the first wind turbine 1a may be continued while the cable supporting structure 7 of the second wind turbine 1b is hoisted. Alternatively, hoisting of the cable supporting structure 7 of the first wind turbine 1a may be interrupted until the cable supporting structure 7 of the second wind turbine 1b has reached the same level as the cable supporting structure 7 of the first wind turbine 1a. In this case, the hoisting of the cable supporting structure 7 of the first wind turbine 1a may be resumed when the cable supporting structure 7 of the second wind turbine 1b reaches the level, while the hoisting of the cable supporting structure 7 of the second wind turbine 1b is interrupted.

In any event, when the cable supporting structure 7 of the second wind turbine 1b reaches the level, hoisting of the cable supporting structure 7 of a third wind turbine 1c is initiated, similarly to the situation described above. The third wind turbine 1c is a neighbouring wind turbine with respect to the second wind turbine 1b.

Thus, the cable supporting structures 7 of the neighbouring wind turbines 1 are sequentially hoisted along the respective main tower parts 2, in a coordinated manner, until a mounting position for each of the cable supporting structures 7 has been reached. Thereby it is avoided that the distance between cable supporting structures 7 of two neighbouring wind turbines 1 exceeds the length of the power cables 8 interconnecting the two cable supporting structures 7. This allows the power cables 8 to be fixed on the cable supporting structures 7 while these are positioned on the ground, thereby minimising the number of operations which are required after the cable supporting structures 7 have been hoisted to the mounting position. This increases the safety and reduces the costs during installation.

FIG. 8 illustrates a point in time of the process described above, in which the cable supporting structure 7 of the first wind turbine 1a has almost reached the mounting position, the cable supporting structure 7 of the second wind turbine 1b has been hoisted approximately half the distance from the ground to the mounting position, and hoisting of the cable supporting structure 7 of the third wind turbine 1c has just been initiated.

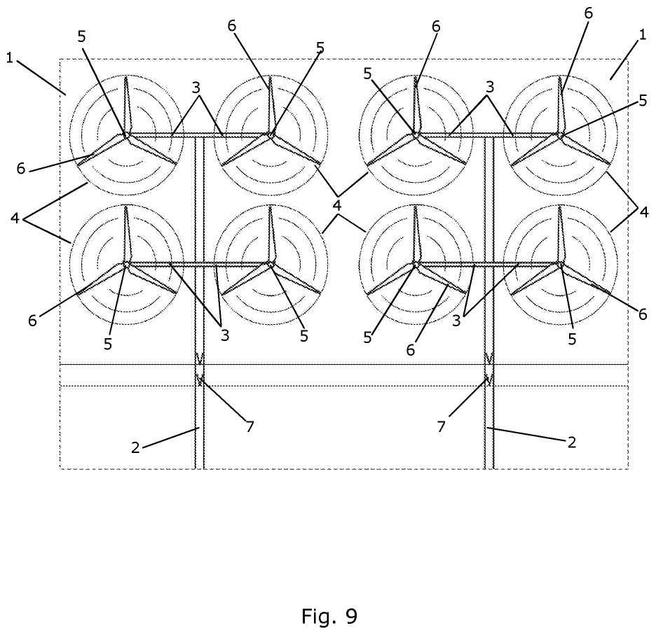

FIG. 9 is a front view of two wind turbines 1 according to a third embodiment of the invention. The wind turbines 1 are similar to the wind turbines illustrated in FIG. 1, and they will therefore not be described in detail here. However, each of the wind turbines 1 illustrated in FIG. 9 comprises four arms 3, each carrying an energy generating unit 4 with a rotor 5 carrying a set of wind turbine blades 6.

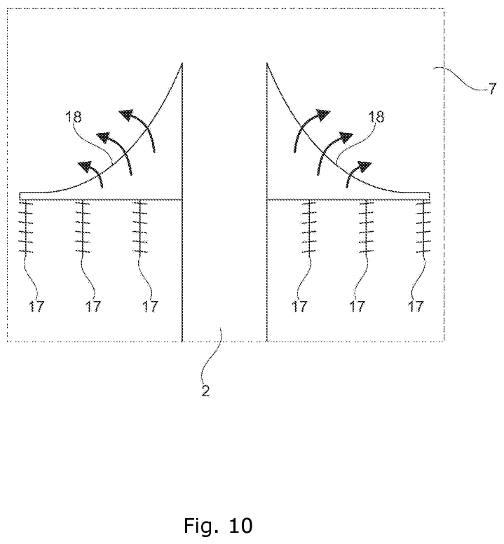

FIGS. 10-12 show cable supporting structures 7 for a wind turbine according to an embodiment of the invention.

FIG. 10 is a cross sectional view of a cable supporting structure 7 mounted on a main tower part 2. The cable supporting structure 7 is provided with cable holders 17, onto which power cables (not shown) can be mounted. The cable supporting structure 7 has an upper surface 18 with a curved shape. The curved shape of the upper surface 18 has the effect that wind flowing towards the cable supporting structure 7 is deflected in an upwards direction. In the case that the cable supporting structure 7 is mounted on the main tower part 2 at a position below the arms carrying the energy generating units, this will cause the wind to be directed towards the rotors of the energy generating units. Thereby the power production of the wind turbine is increased.

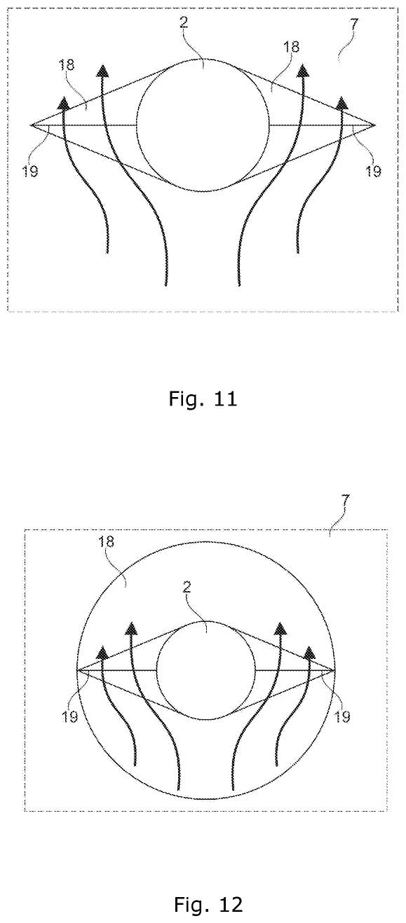

FIG. 11 is a top view of a cable supporting structure 7 mounted on a main tower part 2. The cable supporting structure 7 of FIG. 11 could, e.g., be the cable supporting structure 7 illustrated in FIG. 10. Line 19 indicates the position of the cable holders illustrated in FIG. 10. In the cable supporting structure 7 of FIG. 11, the area of the curved upper surface 18, seen by the wind, is larger when the wind direction is perpendicular to the lines 19, i.e. when the wind direction is parallel to the direction defined by the power cables, than when the wind direction is parallel to the lines 19, i.e. when the wind direction is perpendicular to the direction defined by the power cables. Therefore, the ability of the curved upper surface 18 to deflect the incoming wind in an upwards direction is better when the wind direction is parallel to the direction defined by the power cables. When the wind direction is substantially parallel to the direction defined by the power cables, a higher wind wake, caused by neighbouring wind turbines, must be expected. It is therefore more relevant to direct the wind towards the rotors in this case.

FIG. 12 is a top view of an alternative cable supporting structure 7 mounted on a main tower part 2. The cable supporting structure 7 of FIG. 12 could also be the cable supporting structure 7 illustrated in FIG. 10. However, the cable supporting structure 7 of FIG. 12 is rotationally symmetric, and thereby the ability of the curved upper surface 18 to deflect the incoming wind in an upwards direction is the same, regardless of the direction of the incoming wind.

1. A wind turbine comprising:
a tower structure comprising a main tower part being anchored, at a lower part, to a foundation structure, the main tower part extending along a substantially vertical direction, the tower structure further comprising at least two arms, each arm extending away from the main tower part along a direction having a horizontal component, the arms being arranged to perform yawing movements about an axis defined by the substantially vertical direction of the main tower part, and
two or more energy generating units mounted on the tower structure in such a manner that each arm of the tower structure carries at least one energy generating unit, each energy generating unit comprising a rotor with a hub carrying a set of wind turbine blades,
wherein the main tower part is provided with a cable supporting structure allowing power cables of a power grid to be mounted on the main tower part, the main tower part thereby being configured to function as a power mast.

2. The wind turbine according to claim 1, wherein the arms of the tower structure form part of a single transverse structure.

3. The wind turbine according to claim 1, wherein the cable supporting structure is mounted on the main tower part of the tower structure at a position which is lower than a connecting position between the main tower part and at least two of the arms.

4. The wind turbine according to claim 1, wherein the cable supporting structure is or comprises a cassette arranged to hold the power cables, the cassette being configured to be hoisted along the main tower part of the tower structure.

5. The wind turbine according to claim 1, wherein the cable supporting structure has an aerodynamic shape arranged for directing wind towards the energy generating units.

6. The wind turbine according to claim 1, wherein the cable supporting structure is mounted on the main tower part of the tower structure via a vibration dampening arrangement.

7. The wind turbine according to claim 1, wherein a service crane arranged in the tower structure or in one of the energy generating units is configured for use during service of the power cables and/or the cable supporting structure.

8. The wind turbine according to claim 7, wherein at least one of the arms of the tower structure is provided with a hatch allowing a part of the service crane to pass there through.

9. A method for performing service on an energy generating unit of a wind turbine according to claim 1, the method comprising the steps of:
performing yawing movements of at least one of the arms of the tower structure, in order to move the arm to a position in which an energy generating unit carried by the arm is clear of the power cables mounted on the main tower part, and
performing service on the energy generating unit while the arm is in this position.

10. The method according to claim 9, wherein the step of performing yawing movements comprises moving the arm to a position in which the arm extends away from the main tower part along a direction which defines an angle of approximately 90° with a direction defined by the power cables mounted on the main tower part.

11. The method according to claim 9, wherein the step of performing yawing movements comprises moving the arm to a position in which the arm extends away from the main tower part along a direction which defines an angle of approximately 70° with a direction defined by the power cables mounted on the main tower part.

12. The method for mounting power cables on a wind turbine according to claim 1, he method comprising the steps of:
arranging a cassette on the ground at a position near the main tower part of the tower structure,
attaching power cables to the cassette,
attaching the power cables to cassettes of at least one neighbouring wind turbine, and
hoisting the cassette along the main tower part, the hoisting being coordinated with hoisting the cassettes of the neighbouring wind turbines.

13. The method according to claim 12, wherein the step of hoisting the cassette is performed using a jacking mechanism.

14. The method according to claim 12, wherein the step of hoisting the cassette is performed using at least one service crane arranged in the tower structure or in one of the energy generating units of the wind turbine.

15. The method according to claim 12, further comprising the steps of mounting the power cables on the main tower part by means of a cable supporting structure, and subsequently lowering the cassette to the ground.

16. The method according to claim 12, further comprising the step of mounting the cassette on the main tower part, the cassette thereby forming a cable supporting structure.
